(19) United States
(12) Patent Application Publication
(10) Pub. No.: US 2005/0189505 A1
(43) Pub. Date: Sep. 1, 2005

(54) Erasing device

(75) Inventors: Masakazu Nakajo, Minami-ashigara-shi (JP); Hideki Suzuki, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/063,537

(22) Filed: Feb. 24, 2005

(30) Foreign Application Priority Data
Feb. 26, 2004 (JP) 2004-051838

(51) Int. Cl. G03B 42/08

(52) U.S. Cl. 250/588

(57) ABSTRACT

A preceding erasure time stored in an IC chip embedded in a stimulable phosphor sheet is read in step S3. After radiation image information is read from the stimulable phosphor sheet in step S5, an elapsed time up to the present time is calculated in step S6, and a required amount of erasing light corresponding to the elapsed time is read from a required-amount-of-applied-light memory in step S7. An erasing light application time is calculated from the radiation image information and the read required amount of erasing light in step S8. Erasing light sources are energized for the calculated erasing light application time to apply erasing light to the stimulable phosphor sheet to erase remaining radiation energy therefrom in step S10.

### BACKGROUND OF THE INVENTION

1. Field of the Invention

The present invention relates to an erasing device for applying erasing light to a stimulable phosphor panel to erase radiation energy remaining in the stimulable phosphor panel.

2. Description of the Related Art

There has heretofore been known a stimulable phosphor which, when exposed to an applied radiation (X-rays, α-rays, β-rays, γ-rays, electron beams, ultraviolet radiation, or the like), stores part of the energy of the radiation, and, when subsequently exposed to applied stimulating rays such as visible light, emits light in proportion to the stored energy of the radiation. A radiation image information recording and reproducing system, which is employed in the art, temporarily records radiation image information of a subject such as a human body on a stimulable phosphor panel having a stimulable phosphor layer. Thereafter, the radiation image information recording and reproducing system applies stimulating light such as a laser beam or the like to the stimulable phosphor panel to emit light representative of the recorded radiation image information, and then outputs the radiation image information as a visible image on a recording medium such as a photographic photosensitive medium or the like or a display unit such as a CRT or the like, based on an image signal that is generated by photoelectrically reading the light emitted from the stimulable phosphor panel (see Japanese Laid-Open Patent Publication No. 55-12429 for details). After the radiation image information has been read from the stimulable phosphor panel, the stimulable phosphor panel is irradiated with erasing light to erase any remaining radiation energy therefrom, and then used again for recording radiation image information thereon.

If remaining radiation energy on the stimulable phosphor panel is not fully erased, then next radiation image information recorded on the stimulable phosphor panel may not be read and displayed properly. Such a drawback may be avoided by applying an increased amount of erasing light to the stimulable phosphor panel.

However, simply increasing the amount of erasing light applied to the stimulable phosphor panel tends to degrade the stimulable phosphor panel by the heat of the erasing light and a long period of time to finish the erasing process is required.

Japanese Laid-Open Patent Publication No. 11-311848 discloses a radiation image erasing apparatus and method for adjusting an amount of erasing light depending on the amount of radiation energy applied to a stimulable phosphor panel for thereby erasing remaining radiation energy with a minimum amount of erasing light. Japanese Laid-Open Patent Publication No. 4-1630 discloses an erasing device for adjusting an amount of erasing light depending on the type of a stimulable phosphor panel used in view of different amounts of erasing light required for different types of stimulable phosphor panels.

Even if a required amount of erasing light is applied to a stimulable phosphor panel to erase remaining radiation energy therefrom, it is not guaranteed that no radiation energy remains on the stimulable phosphor panel in a next radiation image exposure process. For example, if a long period of time elapses before a next radiation image exposure process, then radiation energy that has remained within the stimulable phosphor layer of the stimulable phosphor panel may appear as a residual image on the surface of the stimulable phosphor panel. Natural radiation applied while the stimulable phosphor panel is in storage may appear as noise. Therefore, an amount of erasing light to be applied to a stimulable phosphor panel needs to be selected based on not only the amount of radiation energy applied to the stimulable phosphor panel and the type of the stimulable phosphor panel, but also the period of time that has elapsed from the preceding radiation image exposure process.

Usually, when the radiation image information recording and reproducing system starts to operate, each stimulable phosphor panel used therein is processed in an erasing process in order to eliminate the effect of radiation energy remaining in the stimulable phosphor panel. Since the application of erasing light in an amount greater than necessary to a stimulable phosphor panel consumes wasteful energy for erasing remaining radiation energy from the stimulable phosphor panel or needs a long period of time until remaining radiation energy is erased from the stimulable phosphor panel, an amount of erasing light to be applied to the stimulable phosphor panel has to be selected in view of these undesirable factors.

### SUMMARY OF THE INVENTION

It is a general object of the present invention to provide an erasing device for erasing radiation energy remaining in a stimulable phosphor panel with a minimum amount of erasing light required thereby to reduce the amount of energy and the processing time required to erase the remaining radiation energy and to erase the radiation energy efficiently and reliably.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a schematic vertical cross-sectional view of an image reading apparatus incorporating an erasing device according to an embodiment of the present invention;

FIG. 2 is a perspective view of a cassette and a stimulable phosphor sheet to be loaded into the image reading apparatus;

FIG. 3 is a block diagram of a control circuit of the image reading apparatus;

FIG. 4 is a flowchart of an operation sequence of the image reading apparatus;

FIG. 5 is a diagram illustrative of data stored in a required-amount-of-applied-light memory of the image reading apparatus; and

FIG. 6 is a block diagram of a control circuit of an image reading apparatus according to another embodiment of the present invention.

### DESCRIPTION OF THE PREFERRED EMBODIMENTS

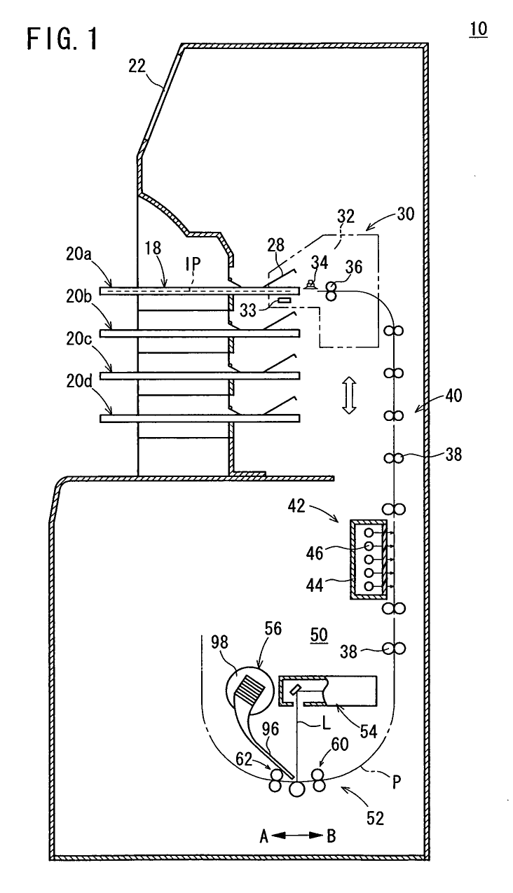

FIG. 1 shows in vertical cross section an image reading apparatus 10 incorporating an erasing device according to an embodiment of the present invention.

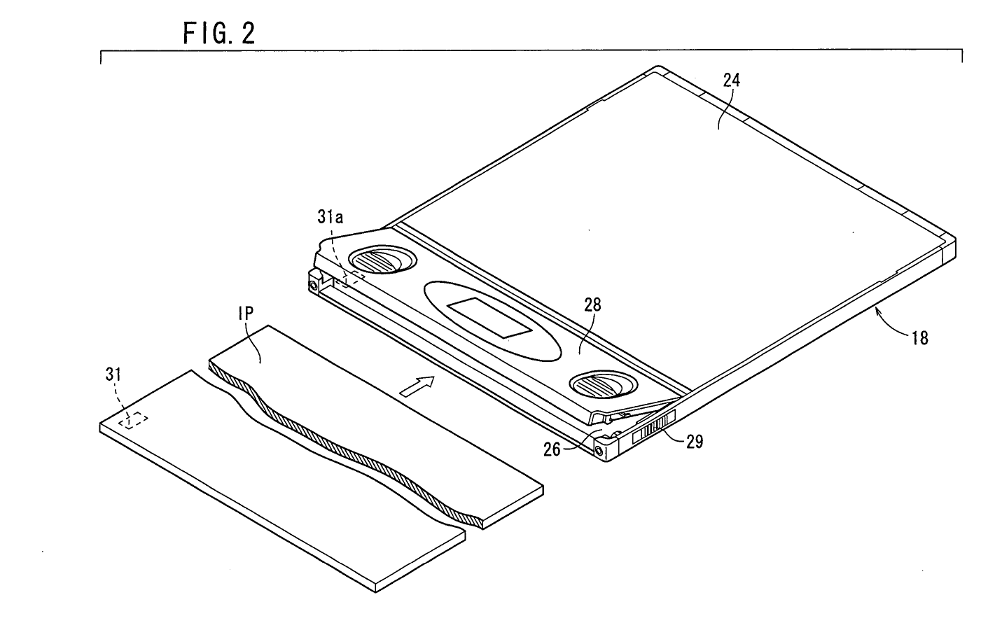

As shown in FIG. 1, the image reading apparatus 10 has in its upper section a plurality of cassette loaders 20a, 20b, 20c, 20d each loaded with a cassette 18 (see FIG. 2) housing therein a stimulable phosphor sheet IP as a stimulable phosphor panel with the radiation image information of a subject being recorded therein. The image reading apparatus 10 also has a touch panel 22 disposed above the uppermost cassette loader 20a for displaying an operation status and a control procedure of the image reading apparatus 10 and also entering necessary commands.

The cassette 18 comprises a casing 24 for storing the stimulable phosphor sheet IP therein and a lid 28 openably and closably hinged to the casing 24. When the lid 28 is opened, an opening 26 is defined between the lid 28 and the casing 24 for inserting the stimulable phosphor sheet IP into and removing the stimulable phosphor sheet IP from the casing 24. A bar-code label 29 representing identification information such as an ID number or the like of the cassette 18 is applied to a side panel of the casing 24.

The stimulable phosphor sheet IP comprises a flexible panel, and carries an embedded IC chip 31 (erasure time memory means) as an RFID (Radio Frequency Identification) medium for storing an erasure time which represents the time when radiation image information is erased as described later. If a certain stimulable phosphor sheet IP and a certain cassette 18 are necessarily associated with each other, then an IC chip 31a as an RFID medium may be applied to the cassette 18. If the image reading apparatus 10 has a straight feed path for the stimulable phosphor sheet IP, then the stimulable phosphor sheet IP may comprise a hard panel having a columnar stimulable phosphor layer evaporated on a hard material such as glass or the like.

The image reading apparatus 10 has a vertically movable sheet feeder 30 vertically movable into alignment with one of the cassette loaders 20a through 20d for removing the stimulable phosphor sheet IP from the cassette 18 to read and erase radiation image information therefrom, and also for returning the stimulable phosphor sheet IP into the cassette 18 after radiation image information is read and erased therefrom. The vertically movable sheet feeder 30 has a base 32 that is vertically movable into alignment with one of the cassette loaders 20a through 20d. The base 32 supports thereon a suction cup 34 movable into and out of the cassette 18 through the opening 26, a feed roller pair 36 for receiving and feeding the stimulable phosphor sheet IP attracted by the suction cup 34, and a reader-recorder 33 for reading an erasure time from and recording an erasure time in the IC chip 31 embedded in the stimulable phosphor sheet IP or the IC chip 31a applied to the cassette 18.

A feed path 40 having a plurality of roller pairs 38 extends downwardly from the vertically movable sheet feeder 30. An erasing unit 42 is disposed along the feed path 40. The erasing unit 42 comprises a casing 44 and a vertical array of erasing light sources 46 disposed in the casing 44.

A reading unit 50 is disposed below the feed path 40. The reading unit 50 comprises an auxiliary scanning feed mechanism 52 for feeding the stimulable phosphor sheet IP in an auxiliary scanning direction indicated by the arrow A or B, an optical system 54 for applying a laser beam L as stimulating light to the stimulable phosphor sheet IP that is fed in the auxiliary scanning direction while the laser beam L is being deflected repeatedly in a main scanning direction that is substantially perpendicular to the auxiliary scanning direction, and a light collecting system 56 for photoelectrically reading light that is emitted from the stimulable phosphor sheet IP when it is exposed to the laser beam L.

The auxiliary scanning feed mechanism 52 has first and second roller pairs 60, 62 for feeding the stimulable phosphor sheet IP in the auxiliary scanning direction. The light collecting system 56 comprises a light guide 96 having an end disposed along the portion of the stimulable phosphor sheet IP which is scanned by the laser beam L, and a photomultiplier 98 mounted on the other end of the light guide 96.

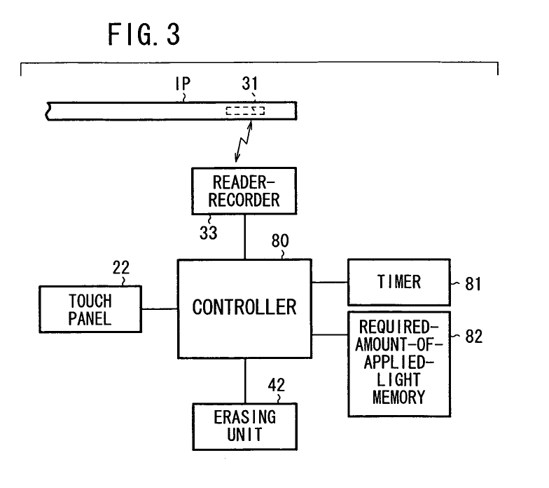

FIG. 3 shows a control circuit of the image reading apparatus 10. The control circuit includes a controller 80 (an elapsed time calculating means, a required-amount-of-applied-light setting means) for controlling the image reading apparatus 10 in its entirety. The touch panel 22, the reader-recorder 33 (an erasure time reading means, an erasure time recording means) for reading the erasure time from and recording the erasure time in the IC chip 31 embedded in the stimulable phosphor sheet IP or the IC chip 31a applied to the cassette 18, and the erasing unit 42 (an erasing means) which erases the energy of the radiation remaining in the stimulable phosphor sheet IP, are connected to the controller 80. In addition, a required-amount-of-applied-light memory 82 (a required-amount-of-applied-light memory means) for storing a required amount of erasing light to be applied by the erasing unit 42 in relation to an elapsed time from a preceding erasing process, and a timer 81 for setting a present time are also connected to the controller 80.

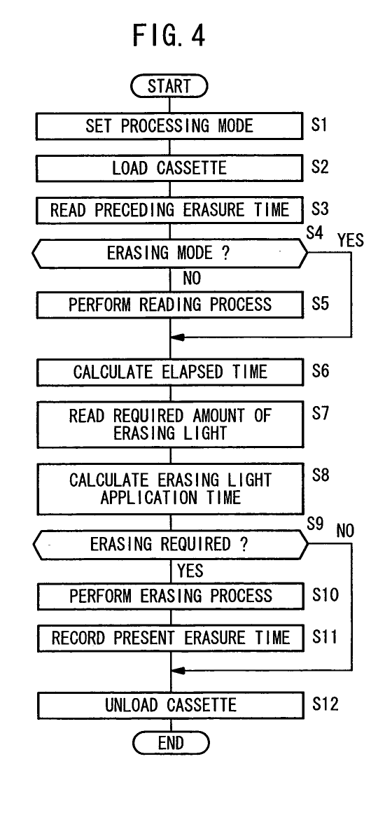

The image reading apparatus 10 is basically constructed as described above. Operation of the image reading apparatus 10 will be described below with reference to FIG. 4.

First, the operator operates the touch panel 22 to set a processing mode in step S1. A processing mode thus set may be a reading mode for reading radiation image information recorded in the stimulable phosphor sheet IP or an erasing mode for erasing remaining radiation image information from the stimulable phosphor sheet IP.

After a desired processing mode is set, the operator loads the cassette 18 housing the stimulable phosphor sheet IP into a selected one of the cassette loaders 20a through 20d in step S2. When the cassette 18 is loaded, the reader-recorder 33 of the vertically movable sheet feeder 30 reads a preceding erasure time that is recorded in the IC chip 31 embedded in the stimulable phosphor sheet IP stored in the cassette 18 or the IC chip 31a applied to the cassette 18 in step S3. It is assumed that the IC chips 31, 31a have recorded such an erasure time as described later on.

If the reading mode is set as the processing mode in step S4, then recorded radiation image information is read from the stimulable phosphor sheet IP in step S5.

Specifically, the lid 28 of the cassette 18 is opened by a lid opening mechanism (not shown), and then the suction cup 34 on the base 32 is moved through the opening 26 into the cassette 18. The suction cup 34 attracts the stimulable phosphor sheet IP in the cassette 18. The suction cup 34 is moved out of the cassette 18, removing the stimulable phosphor sheet IP from the cassette 18 and transferring the stimulable phosphor sheet IP to the feed roller pair 36.

The feed roller pair 36 grips the stimulable phosphor sheet IP and supplies the stimulable phosphor sheet IP to the feed path 40. The roller pairs 38 are rotated to feed the stimulable phosphor sheet IP down the feed path 40 until the stimulable phosphor sheet IP reaches the auxiliary scanning feed mechanism 52 of the reading unit 50.

In the auxiliary scanning feed mechanism 52, the stimulable phosphor sheet IP is fed horizontally in the auxiliary scanning direction indicated by the arrow A by the first and second roller pairs 60, 62. At the same time, the optical system 54 applies the laser beam L to the stimulable phosphor sheet IP to scan the stimulable phosphor sheet IP in the main scanning direction. The application of the laser beam L causes the stimulable phosphor sheet IP to emit light representative of the recorded radiation image information. The emitted light is guided by the light guide 96 and photoelectrically read by the photomultiplier 98.

After the recorded radiation image information is read from the stimulable phosphor sheet IP, the stimulable phosphor sheet IP is fed in the auxiliary scanning direction indicated by the arrow B by the first and second roller pairs 60, 62, back to the erasing unit 42 on the feed path 40.

The controller 80 calculates an elapsed time from the preceding erasing process, using the preceding erasure time read in step S3 and the present time set by the timer 81, in step S6. Depending on the elapsed time, the controller 80 reads a required amount of erasing light which is necessary to erase remaining radiation image information from the stimulable phosphor sheet IP, from the required-amount-of-applied-light memory 82 in step S7.

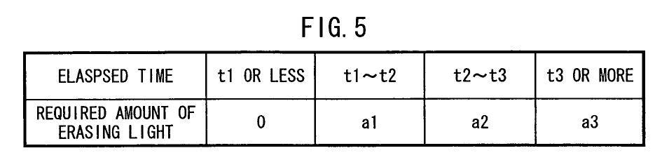

As shown in FIG. 5, the required-amount-of-applied-light memory 82 stores required amounts 0, a1, a2, a3 (0<a1<a2<a3) of erasing light associated respectively with an elapsed time t1 or less, an elapsed time t1 to t2, an elapsed time t2 to t3, an elapsed time t3 or more (t1<t2<t3). For the elapsed time t1 or less, the required amount of erasing time is set to 0 because any remaining radiation energy in the stimulable phosphor sheet IP will not appear as a residual image on the surface of the stimulable phosphor sheet IP.

Based on the radiation image information read in step S5, the controller 80 calculates a required amount of erasing light which is necessary to erase radiation image information remaining in the stimulable phosphor sheet IP after the radiation image information is read therefrom. The controller 80 then adds the calculated required amount of erasing light to the required amount of erasing light, read from the required-amount-of-applied-light memory 82, which is necessary to erase any residual image that appears depending on the elapsed time from the preceding erasing process. The controller 80 calculates an erasing light application time required to obtain the sum amount of erasing light from the erasing light sources 46 in step S8. If the intensity of erasing light emitted from the erasing light sources 46 can be controlled, then the controller may keep the erasing light application time constant and may control the intensity of erasing light emitted from the erasing light sources 46 to obtain the sum amount of erasing light.

Since the remaining radiation image information needs to be erased from the stimulable phosphor sheet IP, the erasing light application time is not nil, but the controller 80 judges that an erasing process is required in step S9, and performs the erasing process in step S10.

The erasing unit 42 energizes the erasing light sources 46 for the erasing light application time calculated in step S8, applying erasing light to erase the remaining radiation image information from the stimulable phosphor sheet IP. Because the erasing light application time is set based on the radiation image information recorded in the stimulable phosphor sheet IP and the elapsed time from the preceding erasing process, the erasing process can reliably be performed with the minimum required amount of erasing light in the erasing light application time.

After the remaining radiation image information is erased from the stimulable phosphor sheet IP, the stimulable phosphor sheet IP is returned into the cassette 18 by the vertically movable sheet feeder 30, and then the lid 28 is closed. At this time, the reader-recorder 33 of the vertically movable sheet feeder 30 records the erasure time at which the present erasing process is performed in the IC chip 31 embedded in the stimulable phosphor sheet IP or the IC chip 31a applied to the cassette 18 in step S11.

The cassette 18 which stores the stimulable phosphor sheet IP for which the erasure time has been recorded is unloaded from the selected one of the cassette loaders 20a through 20d in step S12, and will be used to record radiation image information in a next cycle.

If a certain period of time has elapsed from the previous reading and erasing cycle in the image reading apparatus 10, as when the image reading apparatus 10 is switched on, a residual image or noise may be produced in the stimulable phosphor sheet IP due to radiation energy remaining in the stimulable phosphor sheet IP or natural radiation. In this case, the erasing mode is set on the touch panel 22 in step S1, and only an erasing process is performed on the stimulable phosphor sheet IP.

When the cassette 18 is loaded after the erasing mode is set in step S2, the reader-recorder 33 of the vertically movable sheet feeder 30 reads a preceding erasure time that is recorded in the IC chip 31 embedded in the stimulable phosphor sheet IP stored in the cassette 18 or the IC chip 31a applied to the cassette 18 in step S3. If the erasure time is read from the IC chip 31 embedded in the stimulable phosphor sheet IP, then the data of the erasure time will not be mistaken as data from another stimulable phosphor sheet IP even after the stimulable phosphor sheet IP is removed from the cassette 18 and cleaned, or the cassette 18 is replaced with another cassette 18 for maintenance.

Because the erasing mode is set in step S4, the controller 80 does not read radiation image information from the stimulable phosphor sheet IP, but instead calculates an elapsed time from the preceding erasing process, using the preceding erasure time read in step S3 and the present time set by the timer 81, in step S6. Depending on the elapsed time, the controller 80 reads a required amount of erasing light which is necessary to erase remaining radiation image information from the stimulable phosphor sheet IP, from the required-amount-of-applied-light memory 82 in step S7.

The controller 80 then calculates an erasing light application time required from the required amount of erasing light read from the required-amount-of-applied-light memory 82 in step S8. If the elapsed time from the preceding erasing process is longer than the elapsed time t1, then the controller 80 judges that a residual image may possibly be produced and hence an erasing process needs to be performed in step S9. The controller 80 then performs an erasing process for the calculated erasing light application time in step S10. Because the erasing light application time is set based on the elapsed time from the preceding erasing process, the erasing process can reliably be performed with the minimum required amount of erasing light in the erasing light application time.

After the remaining radiation image information is erased from the stimulable phosphor sheet IP, the stimulable phosphor sheet IP is returned into the cassette 18 by the vertically movable sheet feeder 30, and then the lid 28 is closed. At this time, the reader-recorder 33 of the vertically movable sheet feeder 30 records the erasure time at which the present erasing process is performed in the IC chip 31 embedded in the stimulable phosphor sheet IP in step S11.

If the elapsed time from the preceding erasing process is equal to or shorter than the elapsed time t1, then the controller 80 judges that no residual image will be produced, and the required amount of erasing time is set to 0. Therefore, the controller 80 does not perform an erasing process on the stimulable phosphor sheet IP, and immediately unloads the cassette 18 in step S12. Since an unnecessary erasing process is avoided, radiation image information can quickly be recorded on the stimulable phosphor sheet IP.

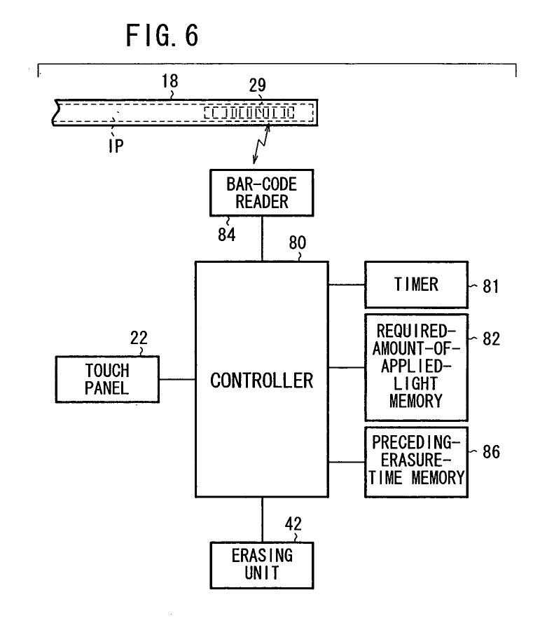

In the present embodiment, the reader-recorder 33 reads an erasure time from and records an erasure time in the IC chip 31 embedded in the stimulable phosphor sheet IP or the IC chip 31a applied to the cassette 18. If a specific stimulable phosphor sheet IP is stored in the cassette 18, then, as shown in FIG. 6, the bar-code label 29 applied to the side panel of the casing 24 of the cassette 18 may be used.

Specifically, specific information which specifies the stimulable phosphor sheet IP and a preceding erasure time at which a preceding erasing process has been performed on the stimulable phosphor sheet IP that is specified by the specific information are associated with each other and stored in a preceding-erasure-time memory 86. When the cassette 18 is loaded into the image reading apparatus 10, the bar-code label 29 on the cassette 18 is read by a bar-code reader 84 disposed in the image reading apparatus 10 to specify the stimulable phosphor sheet IP. The preceding erasure time of the specified stimulable phosphor sheet IP is read from the preceding-erasure-time memory 86. Then, an elapsed time from the preceding erasing process is calculated from the preceding erasure time and the present time, and an erasing process is performed on the stimulable phosphor sheet IP according to the calculated elapsed time.

Although certain preferred embodiments of the present invention have been shown and described in detail, it should be understood that various changes and modifications may be made therein without departing from the scope of the appended claims.

1. An erasing device for applying erasing light to a stimulable phosphor panel to erase radiation energy remaining in said stimulable phosphor panel, comprising:
erasure time memory means for storing a preceding erasure time at which the erasing light is applied to said stimulable phosphor panel in a preceding erasing process;
elapsed time calculating means for calculating an elapsed time from said preceding erasure time;
required-amount-of-applied-light setting means for setting a required amount of erasing light which is necessary to erase radiation energy remaining in said stimulable phosphor panel, based on the calculated elapsed time; and
erasing means for applying the required amount of erasing light to said stimulable phosphor panel.

2. An erasing device according to claim 1, further comprising:
required-amount-of-applied-light memory means for storing said required amount of erasing light with respect to said elapsed time;
wherein said required-amount-of-applied-light setting means reads said required amount of erasing light with respect to said elapsed time from said required-amount-of-applied-light memory means, and sets said required amount of erasing light.

3. An erasing device according to claim 1, further comprising:
erasure time recording means for recording an erasure time at which said erasing light is applied to said stimulable phosphor panel in said erasure time memory means; and
erasure time reading means for reading said erasure time recorded with respect to said stimulable phosphor panel from said erasure time memory means.

4. An erasing device according to claim 3, wherein said erasure time memory means comprises a memory device for recording said erasure time therein and reading said erasure time therefrom in a contactless fashion.

5. An erasing device according to claim 3, wherein said erasure time memory means is held by said stimulable phosphor panel.

6. An erasing device according to claim 3, wherein said erasure time memory means is held by a cassette which stores said stimulable phosphor panel.

7. An erasing device according to claim 1, wherein said stimulable phosphor panel comprises specific information holding means for holding specific information specifying said stimulable phosphor panel; and
wherein said erasure time memory means stores the preceding erasure time corresponding to said specific information.

8. An erasing device according to claim 7, wherein said specific information holding means comprises a bar code applied to a cassette which stores said stimulable phosphor panel and representing said specific information.

9. An erasing device according to claim 1, wherein said required-amount-of-applied-light setting means sets said required amount of erasing light by adding a required amount of erasing light based on said elapsed time and a required amount of erasing light based on image information recorded in said stimulable phosphor panel.

10. An erasing device according to claim 1, wherein said required-amount-of-applied-light setting means sets said required amount of erasing light as an erasing light application time for said stimulable phosphor panel.

11. An erasing device according to claim 1, wherein said required-amount-of-applied-light setting means sets said required amount of erasing light as an erasing light application intensity for said stimulable phosphor panel.
